(19) United States
(12) Patent Application Publication
(10) Pub. No.: US 2026/0063264 A1
(43) Pub. Date: Mar. 5, 2026

(54) HEADLAMP FOR VEHICLES

(71) Applicant: HELLA GmbH & Co. KGaA, Lippstadt (DE)

(72) Inventor: Gerhard KLOOS, Erwitte (DE)

(73) Assignee: HELLA GmbH & Co. KGaA, Lippstadt (DE)

(21) Appl. No.: 19/313,061

(22) Filed: Aug. 28, 2025

(30) Foreign Application Priority Data
Aug. 30, 2024 (DE) 10 2024 124 795.9

(51) Int. Cl. F21S 41/275; F21S 41/255; F21W 102/135

(52) U.S. Cl. CPC F21S 41/275; F21S 41/255; F21W 2102/135

(57) ABSTRACT

A headlamp for vehicles having at least one light source for emitting light. An optical unit has a projection lens for deflecting the light so that a predetermined light distribution with a light/dark boundary is created in a vehicle near field. The projection lens has a Fresnel structure with a multiplicity of annular active faces that deflect the light for the purpose of the light distribution and inactive faces that do not deflect the light for the purpose of the light distribution, such that the active faces have an angle of inclination of a predetermined size relative to a plane that runs perpendicular to an optical axis of the projection lens. The angles of inclination of the active faces that are arranged at a distance from one another in a radial direction are designed to be periodically or aperiodically larger and smaller than the base angle of inclination.

This nonprovisional application claims priority under 35 U.S. C. § 119(a) to German Patent Application No. 10 2024 124 795.9, which was filed in Germany on Aug. 30, 2024, and which is herein incorporated by reference.

### BACKGROUND OF THE INVENTION

### Field of the Invention

The invention relates to a headlamp for vehicles having at least one light source for emitting light, having an optical unit containing a projection lens for deflecting the light so that a predetermined light distribution with a light/dark boundary is created in a vehicle near field, wherein the projection lens has a Fresnel structure with a multiplicity of annular active faces that deflect the light for the purpose of the light distribution and inactive faces that do not deflect the light for the purpose of the light distribution, such that the active faces have an angle of inclination of a predetermined size relative to a plane that runs perpendicular to an optical axis of the projection lens.

### Description of the Background Art

A headlamp for vehicles is known from DE 10 2022 124 019 A1, which is incorporated herein by reference, and which has at least one light source and an optical unit for creating a predetermined light distribution, preferably for creating a low beam light distribution with a light/dark boundary. The optical unit can include multiple optical components, for example a primary optical system that preshapes the light radiated by the light source and a secondary optical system that reshapes the light coming from the primary optical system in accordance with the predetermined light distribution. The secondary optical system is composed of a projection lens that has a Fresnel structure on a light exit side. The Fresnel structure has, on the one hand, a multiplicity of active faces that deflect the light for the purpose of creating the predetermined low beam light distribution. On the other hand, the Fresnel structure has a multiplicity of inactive faces that deflect the light in such a manner that they do not contribute to creation of the predetermined low beam light distribution. In order to soften the light/dark boundary in the low beam light distribution, the Fresnel structure can have a number of active faces that extend at a different angle of inclination relative to a plane running perpendicular to the optical axis of the lens than the other active faces. Undesirable color effects in the low beam light distribution can also be reduced by this means.

### SUMMARY OF THE INVENTION

It is therefore an object of the present invention to improve a headlamp for vehicles so as to provide a predetermined light distribution with the least possible color fringe effect at a light/dark boundary of the same in a manner that is simple in manufacturing terms.

To attain this object, the invention, in an example, is characterized in that the angles of inclination of the active faces that are arranged at a distance from one another in a radial direction are designed to be periodically or aperiodically larger and smaller than the base angle of inclination, wherein the number of first active faces distributed in the radial direction extends at a first angle of inclination that is larger than the base angle of inclination by a first difference angle, and wherein the number of second active faces extends at a second angle of inclination that is smaller than the base angle of inclination by a second difference angle.

A color correction can be accomplished in the predetermined light distribution in that, on the one hand, a number of first active faces of the Fresnel structure each have a first angle of inclination that is larger than a base angle of inclination, and on the other hand, a number of second active faces each have a second angle of inclination that is smaller than the base angle of inclination. In this way, a variation in the active faces is created that achieves only the color correction in the predetermined light distribution, in particular at the light/dark boundary of the light distribution. The variation in the angles of inclination occurs periodically or aperiodically relative to the base angle of inclination, which preferably is calculated by means of an algorithm via a processor and/or computer and preferably achieves the optimum collimating effect of the active faces when all active faces of the Fresnel structure have this base angle of inclination. The base angle of inclination constitutes the starting position, as it were, for a slight tilting of the first active faces in one direction and of the second active faces in the other, opposite direction relative to this starting position. In this connection, a certain reduction in the collimation quality of the Fresnel structure is tolerated so that the undesirable color fringe effect does not manifest to such a degree that regulatory requirements are no longer met.

First adjacent active faces having the first angle of inclination and second adjacent active faces having the second angle of inclination can be arranged in alternation in the radial direction of the Fresnel structure, which is to say toward a circumferential edge of the projection lens starting from the optical axis of the same. For example, the first adjacent active faces can be arranged at a uniform distance from one another. For example, the second adjacent active faces can be arranged at a uniform distance from one another. For example, the first adjacent active faces and the second adjacent active faces can be arranged at a uniform distance from one another. A homogeneous light distribution with no color fringe effect at the light/dark boundary advantageously can be created by this means.

The Fresnel structure can have, running between the active faces in the radial direction of the projection lens, inactive faces that have a uniform height and/or a uniform width. As a result of the fact that the inactive faces are identical in design, and preferably also have the same angle of inclination relative to the plane running perpendicular to the optical axis, annular root lines of the Fresnel structure formed by adjacent active faces and inactive faces run in an undulating fashion along a curve.

The first active faces and the second active faces can have a different height and/or a different width from one another on account of the different angles of inclination thereof, wherein the height is oriented in the axial direction and the width in the radial direction.

The first difference angle of the first active face can be equal in size to the second difference angle of the second active face. This results in a symmetric deviation relative to a center position composed of the base angle of inclination, which is to say the excursion is chosen to be of equal size on both sides of the center position.

The first difference angle of the first active face can be larger than the second difference angle of the second active face. This results in an asymmetric deviation relative to the center position.

The first active faces with the first angle of inclination and the second active faces with the second angle of inclination can be distributed over the entire radial direction of the projection lens. In this way, a maximum degree of color correction can be achieved.

In an example, only a radial subsection of the projection lens may be provided with first active faces and second active faces having the different angles of inclination. The other remaining section of the surface is composed of active faces with a uniform angle of inclination, preferably the base angle of inclination. Advantageously, the subsection is chosen to be only as large as is necessary for the color correction. An optimization of the Fresnel structure can be achieved by means of the remaining section, which is designed optimally with regard to the collimation quality.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic side view of a projection lens according to an example of the invention;

FIG. 2 shows a front view of the projection lens with a Fresnel structure on a light exit surface;

FIG. 3 shows a schematic section through the projection lens along the section line III-III in FIG. 2;

FIG. 4 shows a representation of a symmetric deviation of angles of inclination of the first active faces and the second active faces over a radial distance; and

FIG. 5 shows a representation of an asymmetric deviation of angles of inclination of the first active faces and the second active faces relative to a center position viewed in the radial direction.

### DETAILED DESCRIPTION

A headlamp for vehicles has a number of light sources as well as an optical unit for creating a predetermined light distribution, in particular a low beam light distribution, with a light/dark boundary.

The at least one light source is designed as an LED light source. The optical unit preferably has a primary optical system and a secondary optical system, wherein the primary optical system parallelizes the light radiated from the light source and the secondary optical system projects the light coming from the primary optical system into a vehicle near field to create the light distribution with the light/dark boundary.

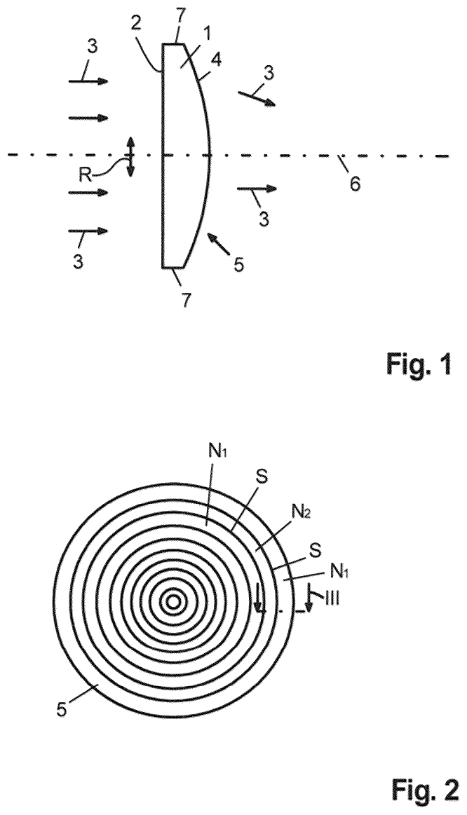

In FIGS. 1 and 2, the secondary optical system is depicted by way of example. It includes a plano-convex projection lens 1 that is flat in design on a light entry side 2 at which light—coming from the primary optical system or the light source—enters. On a light exit side 4 of the projection lens 1 that faces away from the primary optical system or the light source and is designed with a convex shape, the lens has a Fresnel structure 5, which in the present example extends continuously from an optical axis of the projection lens 1 to a circumferential edge 7 of the projection lens 1.

The Fresnel structure 5 has a multiplicity of active faces N₁, N₂ and inactive faces S, which are each arranged in a ring shape about the optical axis 6 and which are arranged in alternation in the radial direction R. The radial direction R runs in a plane that runs perpendicular to the optical axis 6. The radial direction R runs from the optical axis 6 toward the circumferential edge 7 of the projection lens 1 and vice versa.

The active faces N₁, N₂ of the Fresnel structure 5 are designed such that they refract or deflect light 3, which serves to create the predetermined light distribution. The inactive faces S are designed such that light refracted or deflected at them does not contribute to creating the predetermined light distribution.

In the present example, first active faces N₁ are provided that extend at a first angle of inclination β₁ relative to a plane E running perpendicular to the optical axis 6. Furthermore, the Fresnel structure 5 has a number of active faces N₂ that extend at a second angle of inclination β₂ relative to the plane E running perpendicular to the optical axis 6.

The characteristic feature of the first active faces N₁ and the second active faces N₂ consists in that they are arranged on both sides of a computed base active face N_{B} that extends at a base angle of inclination α relative to the plane E. The first active face N₁ is arranged on a first side and tilted relative to the base active face N_{B} by a first difference angle Δφ₁, while the second active face N₂ is arranged on the opposite side of the base active face N_{B} and tilted by the difference angle Δφ₂.

The base active face N_{B} has the base angle of inclination α and is computed by an algorithm, for example, so that the Fresnel structure 5 attains an optimized design as a result. In particular, the base active face N_{B} is designed such that the projection lens 1 has an especially high quality collimation.

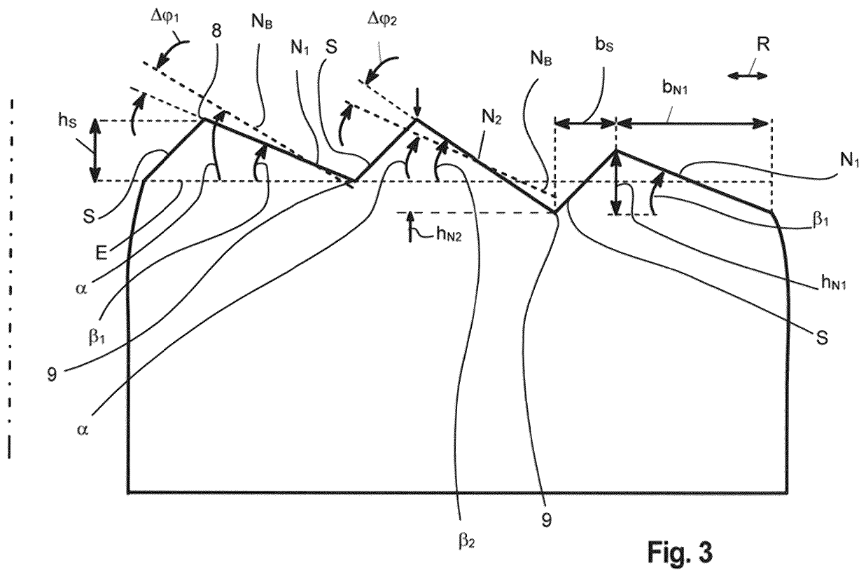

The shape of the base active face N_{B} is represented by a dashed line in FIG. 3. The first active faces N₁ and the second active faces N₂ have a deviation by the difference angles Δφ₁ and Δφ₂ from the base angle of inclination α of the base active face N_{B} so that an undesirable color fringe effect at the light/dark boundary of the light distribution is avoided. To this end, only the first active faces N₁ and the second active faces N₂ are provided in the present example. The angle of inclination β₁ of the first active face N₁ thus corresponds to: β₁=α+Δφ₁. The angle of inclination β₂ of the second active face N₂ thus corresponds to: β₂=α+Δφ₂.

In the present example, the first active faces N₁ and the second active faces N₂ are arranged in alternation with one another in the radial direction R, wherein the inactive face S runs between the first active faces N₁ and the second active faces N₂ in each case.

According to a further example of the invention, the first active faces N₁ and the second active faces N₂ also can be arranged not in alternation in the radial direction R, so that, for example, two first active faces N₁ and then two second active faces N₂ are arranged in the radial direction R. These adjacent first active faces N₁ and the second active faces N₂ can—as in the present example—be arranged periodically in the radial direction R.

These same faces can also be arranged aperiodically, wherein, for example, the number of first active faces N₁ and the number of second active faces N₂ are different as well.

A periodic arrangement of first active faces N₁ and second active faces N₂ of the Fresnel structure 5 preferably is provided for the purpose of creating a high quality collimation and also avoiding the color fringe at the light/dark boundary.

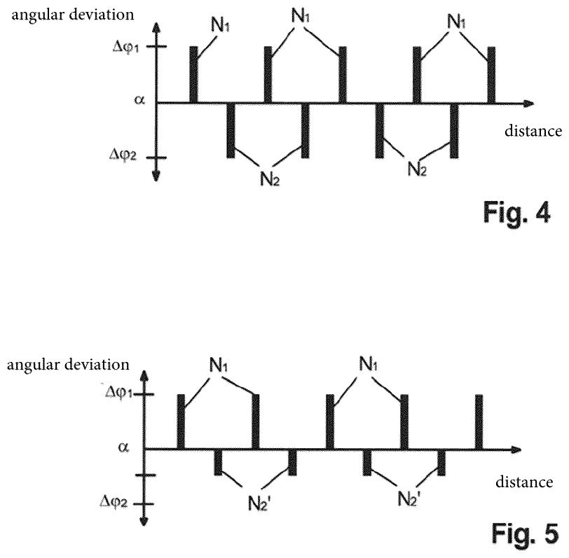

Referring to FIG. 4, the first difference angle Δφ₁ of the first active face N₁ is equal in size to the second difference angle Δφ₂ of the second active face N₂. Consequently, a symmetric deviation of the first active faces N₁ and of the second active faces N₂ relative to the base angle of inclination α of the base active face N_{B} is accomplished in the radial direction R of the Fresnel structure 5, wherein the base angle of inclination α constitutes the center position or neutral position for the first difference angle Δφ₁ and the second difference angle Δφ₂. A relatively uniform mixing of the light 3 with different wavelength components therefore takes place.

According to a further example in accordance with FIG. 5, an asymmetric deviation of difference angles Δφ₁ and Δφ₂ of the active faces N₁ thus formed and second active faces N₂′ can also take place.

As is evident from FIG. 5, the second difference angle Δφ₂ of the second active face N₂′ is smaller in magnitude than the first difference angle Δφ₁ of the first active faces N₁. As a result, the second active faces N₂′ are steeper in comparison with the example according to FIG. 4 than the second active faces N₂ according to the example in accordance with FIGS. 3 and 4.

As is evident from FIG. 3, the inactive faces S always run between the first active faces N₁ and the second active faces N₂. The inactive faces S of the Fresnel structure each have a uniform height h_{S} and a uniform width b_{S}. The height h_{S} of the inactive faces S is composed of the distance of a peak 8 of the Fresnel structure 5 from the plane E that runs through a root line 9 of the Fresnel structure 5 containing the relevant inactive face S. The width b_{S} is the clear distance of the inactive face S projected onto the plane E.

On account of the different angles of inclination β₁, β₂ of the active faces N₁, N₂, said active faces have different heights h_{N1}, h_{N2} and/or different widths b_{N1}, b_{N2}.

As is evident from FIG. 3, the root lines 9 of the Fresnel structure 5 do not run in a common plane, but instead run in an undulating fashion along a curve. Root lines 9 arranged next to one another in the radial direction R therefore run at different heights. The root lines 9 preferably run periodically offset in height along the radial direction R.

In the present example, it is assumed that the first active faces N₁ and the second active faces N₂ with their different angles of inclination β₁, β₂ extend continuously in the radial direction R from the optical axis 6 to the circumferential edge 7.

According to an example of the invention, the first active faces N₁ and second active faces N₂ designed with different angles of inclination β₁, β₂ also can extend only in a radial subsection of the Fresnel structure 5. A remaining section of the Fresnel structure 5 then preferably has solely active faces that have the same angle of inclination, preferably the base angle of inclination α. In this way, an optimum collimation quality can be achieved in the remaining section of the Fresnel structure 5 while a color correction in the light distribution is achieved in the subsection by deviation from the base angle of inclination α.

According to an example of the invention, the Fresnel structure 5 can be arranged on the light entry side 2 of the projection lens 1 instead of on the light exit side 4.

The base angle of inclination α of the base active face N_{B} can lie in a range between 0.1° and 5.0°. The difference angles Δφ₁ and Δφ₂ can lie in a range between 0.05° and 0.5°.

Preferably, the projection lens 1 can be made of a polycarbonate material and can be produced by injection molding.

It should be noted that the light/dark boundary is created by imaging an edge of the light source. Alternatively, it is also possible to provide an additional diaphragm for this purpose that is arranged behind the projection lens in the main direction of emission.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A headlamp for a vehicle, the headlamp comprising:
at least one light source for emitting light; and
an optical unit comprising a projection lens to deflect the light so that a predetermined light distribution with a light/dark boundary is created in a vehicle near field, the projection lens having a Fresnel structure with a plurality of annular active faces that deflect the light for the purpose of the light distribution and inactive faces that do not deflect the light for the purpose of the light distribution, such that the active faces have an angle of inclination of a predetermined size relative to a plane that runs substantially perpendicular to an optical axis of the projection lens,
wherein the angles of inclination of the active faces that are arranged at a distance from one another in a radial direction are designed to be periodically or aperiodically larger and smaller than the base angle of inclination,
wherein the number of first active faces distributed in the radial direction extends at a first angle of inclination that is larger than the base angle of inclination by a first difference angle, and
wherein the number of second active faces extends at a second angle of inclination that is smaller than the base angle of inclination by a second difference angle.

2. The headlamp according to claim 1, wherein the base angle of inclination of the base active face is determined by calculation, wherein it describes an optically optimized design of the projection lens.

3. The headlamp according to claim 1, wherein the first active faces are arranged in alternation with the second active faces in the radial direction of the Fresnel structure.

4. The headlamp according to claim 1, wherein the first difference angle and the second difference angle are chosen such that a color fringe at the light/dark boundary of the light distribution is smaller than a color fringe at the light/dark boundary of the light distribution that is created when the active faces are designed as base active faces with the base angle of inclination.

5. The headlamp according to claim 1, wherein the inactive face is always arranged between the first active faces and/or the second active faces.

6. The headlamp according to claim 1, wherein the inactive faces of the Fresnel structure each have a uniform height and/or a uniform width.

7. The headlamp according to claim 1, wherein the first active face of the Fresnel structure and the second active face of the Fresnel structure have a different height and/or a different width from one another.

8. The headlamp according to claim 1, wherein the first difference angle and the second difference angle are equal in size.

9. The headlamp according to claim 1, wherein the first difference angle is larger than the second difference angle.

10. The headlamp according to claim 1, wherein the active faces with the different angles of inclination extend continuously in the radial direction from the optical axis of the projection lens to the circumferential edge of the projection lens.

11. The headlamp according to claim 1, wherein the first active faces and the second active faces extend between the optical axis and the circumferential edge of the projection lens at least in a radial subsection, and wherein the Fresnel structure has the base active faces in a remaining section.

12. The headlamp according to claim 1, wherein the Fresnel structure is arranged on a light exit side of the projection lens.

13. The headlamp according to claim 1, wherein the projection lens is plano-convex.

14. The headlamp according to claim 1, wherein the base angle of inclination lies in a range between 0.1° and 5.0°.

15. The headlamp according to claim 1, wherein the projection lens is made of a polycarbonate material.
